(19) United States
(12) Patent Application Publication
(10) Pub. No.: US 2025/0079686 A1
(43) Pub. Date: Mar. 6, 2025

(54) ANTENNA MOUNT AND RELATED ANTENNA ASSEMBLIES

(71) Applicant: Outdoor Wireless Networks LLC, Claremont, NC (US)

(72) Inventor: Matthew Robert Lewry, Fife (GB)

(21) Appl. No.: 18/810,957

(22) Filed: Aug. 21, 2024

Related U.S. Application Data
(60) Provisional application No. 63/580,625, filed on Sep. 5, 2023.

(51) Int. Cl. H01Q 1/12; F16M 13/02

(52) U.S. Cl. CPC H01Q 1/1264; F16M 13/022

(57) ABSTRACT

The present disclosure describes an antenna mount. The antenna mount includes a clamp section including one or more clamping members, the one or more clamping members configured to engage a mounting structure, at least one adjustable plate pivotably coupled to at least one of the one or more clamping members, and an azimuth adjustment mechanism coupled to the at least one of the clamping members and the at least one adjustable plate. Through rotation of the azimuth adjustment mechanism, the at least one adjustable plate is configured to linearly move relative to the one or more clamping members to adjust an azimuth alignment of an antenna coupled thereto. Related antenna assemblies are also described herein.

### RELATED APPLICATION(S)

The present application claims priority to and the benefit of U.S. Provisional Patent Application Ser. No. 63/580,625, filed Sep. 5, 2023, the disclosures of which are hereby incorporated by reference in their entirety.

### FIELD

The present application is directed generally toward telecommunications equipment, and more particularly, to an antenna mount for a point-to-point antenna, and related antenna assemblies.

### BACKGROUND

Many point-to-point backhaul communication links utilize traditional dish antennas consisting of a parabolic reflector and a single antenna element that illuminates the reflector. Advantageously, these dish antennas are relatively simple in design and can achieve relatively large antenna gain. Nonetheless, these antennas can exhibit some disadvantages. For example, the transmit power may be limited by the available output power of an amplifier, which can mean that costly semiconductor technologies may have to be used and/or parabolic reflector size may have to be increased to obtain sufficiently large effective isotropic radiated power (EIRP) levels. However, large reflector sizes typically yield narrower beamwidths, which can lead to static alignment difficulties during installation and dynamic alignment difficulties during adverse weather conditions, and lower net data rates. This is because the beam width is so fine that it become nearly impossible to reliably point/align and continuously hold the antenna beam on a required target in order to maintain adequate system gain. For example, at 80 Ghz, the beamwidth for the antenna is very small (e.g., 0.5 degrees) which can make initial alignment of antennas difficult during installation. In addition, current adjustments are made with bolts and small changes in adjustment can result in large angular shifts. Even locking off hardware can result in minor changes in adjustment. Thus, there may be a need for an antenna mount that allows for small alignment adjustments (e.g., with respect to azimuth) as well as allows for easy installation.

### SUMMARY

A first aspect of the present invention is directed to an antenna mount. The antenna mount includes a clamp section including one or more clamping members, the one or more clamping members configured to engage a mounting structure, at least one adjustable plate pivotably coupled to at least one of the clamping members, and an azimuth adjustment mechanism coupled to at least one of the one or more clamping members and the at least one adjustable plate. Through rotation of the azimuth adjustment mechanism, the at least one adjustable plate is configured to linearly move relative to the one or more clamping members to adjust an azimuth alignment of an antenna coupled thereto.

A second aspect of the present invention is directed to an antenna mount. The antenna mount includes a clamp section including a pair of clamping members, the clamping members configured to engage a mounting structure, a pair of adjustable plates pivotably coupled to one of the clamping members, and an azimuth adjustment mechanism coupled to one of the clamping members and the pair of adjustable plates. The azimuth adjustment mechanism includes a first threaded section coupled to a second threaded section, the first threaded section having a right-hand thread and the second threaded section having a left hand thread, a first boss member coupled to the clamping member, and a second boss member coupled to the pair of adjustable plates. The first threaded section extends through an aperture in the first boss member and the second threaded section extends through an aperture in the second boss member. The azimuth adjustment mechanism is configured such that as the first or second threaded section is rotated, the first and second boss members move toward each other or away from each other which cause the pair of adjustable plates to linearly move relative to the clamping member to adjust an azimuth alignment of an antenna coupled thereto.

A third aspect of the present invention is directed to an antenna mount assembly. The antenna mount assembly includes a mounting structure, an antenna having a main reflector, and an antenna mount configured to secure the antenna to the mounting structure. The antenna mount includes a clamp section including a pair of clamping members, the clamping members configured to engage a mounting structure, a pair of adjustable plates pivotably coupled to one of the clamping members, and an azimuth adjustment mechanism coupled to one of the clamping members and the pair of adjustable plates. Through rotation of the azimuth adjustment mechanism, the pair of adjustable plates are configured to linearly move relative to the clamping member to adjust an azimuth alignment of the antenna.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a rear perspective view of an antenna assembly according to embodiments of the present invention.

FIG. 2 is an antenna mount according to embodiments of the present invention utilized in the antenna assembly of FIG. 1.

FIG. 3 is an enlarged side view the antenna mount of FIG. 2 and the azimuth adjustment mechanism according to embodiments of the present invention.

FIG. 4A is a top perspective view of the antenna mount of FIG. 2 illustrating the azimuth adjustment mechanism fully retracted according to embodiments of the present invention.

FIG. 4B is a top perspective view of the antenna mount of FIG. 2 illustrating the azimuth adjustment mechanism fully extended according to embodiments of the present invention.

FIG. 5A is a top view of the antenna assembly of FIG. 1 with the azimuth adjustment mechanism of the antenna mount fully retracted as shown in FIG. 4A according to embodiments of the present invention.

FIG. 5B is a top view of the antenna assembly of FIG. 1 with the azimuth adjustment mechanism of the antenna mount fully extended as shown in FIG. 4B according to embodiments of the present invention.

FIG. 6 is a top view of an alternative configuration of the antenna mount of FIG. 2 configured to secure an antenna to a smaller diameter mounting pole according to embodiments of the present invention.

FIG. 7A is a front perspective view of the antenna mount of FIG. 2.

FIG. 7B is a cross-sectional view of an exemplary elevation adjuster of the antenna mount of FIG. 2 according to embodiments of the present invention.

FIG. 8A is a top view of the antenna assembly of FIG. 1 with the elevation adjuster of the antenna mount fully retracted according to embodiments of the present invention.

FIG. 8B is a top view of the antenna assembly of FIG. 1 with the elevation adjuster of the antenna mount fully extended according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10″′).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

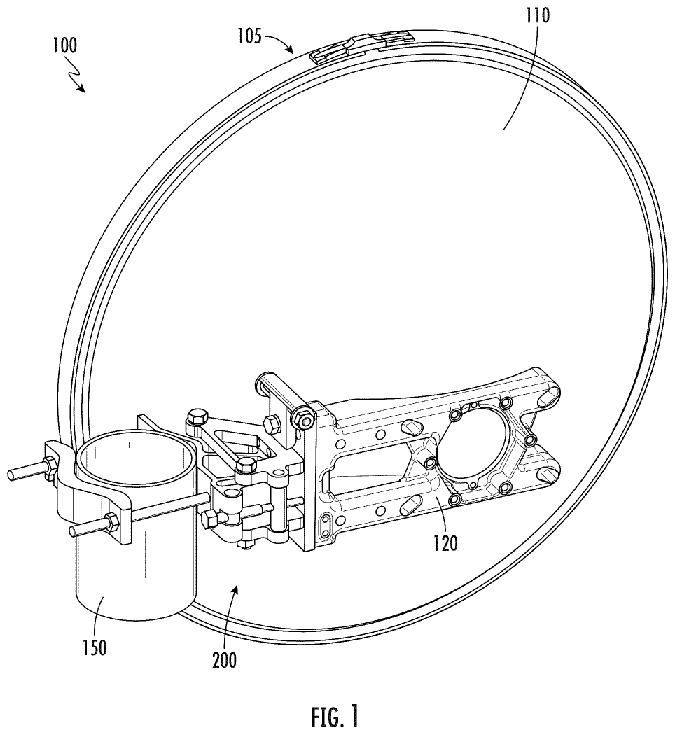

Pursuant to embodiments of the present invention, an antenna mount and related antenna assemblies are provided. The antenna mount of the present invention allows for finer resolution in azimuth adjustment of an antenna and provides higher stability than antenna mounts that are currently available in the market. In some embodiments, the antenna mount of the present invention may also allow for elevation adjustment. Embodiments of the present invention will now be discussed in greater detail with reference to FIGS. 1-8B.

Referring now to FIG. 1, an antenna assembly according to embodiments of the present invention, designated broadly at 100, is illustrated. As shown in FIG. 1, the antenna assembly 100 includes an antenna 105 having a main reflector 110 and an antenna mount 200. The main reflector 110 of the antenna 105 is coupled to the antenna mount 200 via a reflector mount 120. In some embodiments, the main reflector 110 has a parabolic shape. In some embodiments, the antenna assembly 100 may be used with a point-to-point antenna. For example, in some embodiments, the antenna assembly 100 may be used with a millimeter wave (mmWave) antenna. According to embodiments of the present invention, the antenna mount 200 is configured to secure the antenna assembly 100 to a mounting structure 150 (e.g., a pole or pipe).

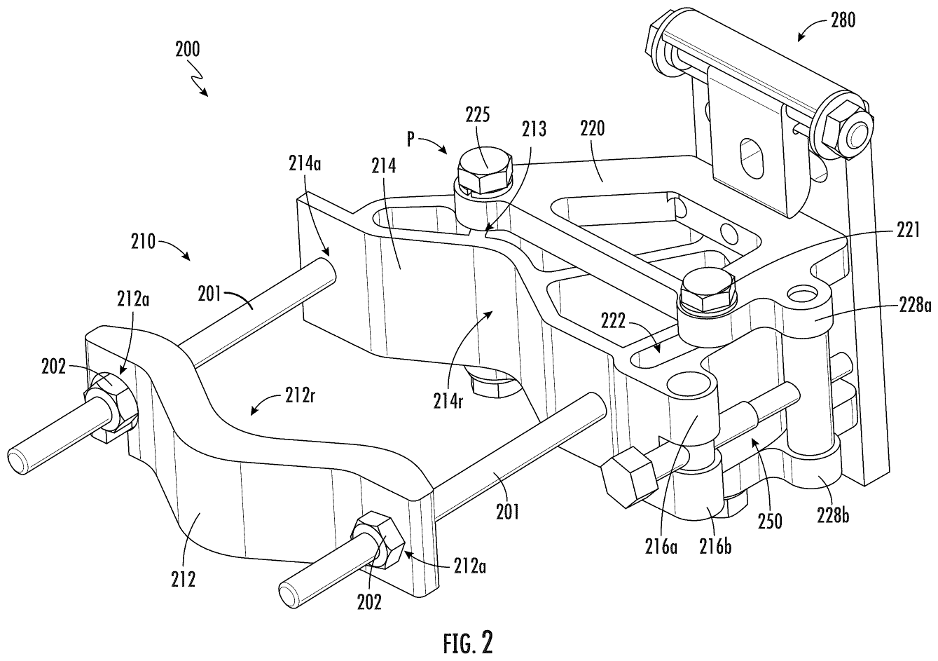

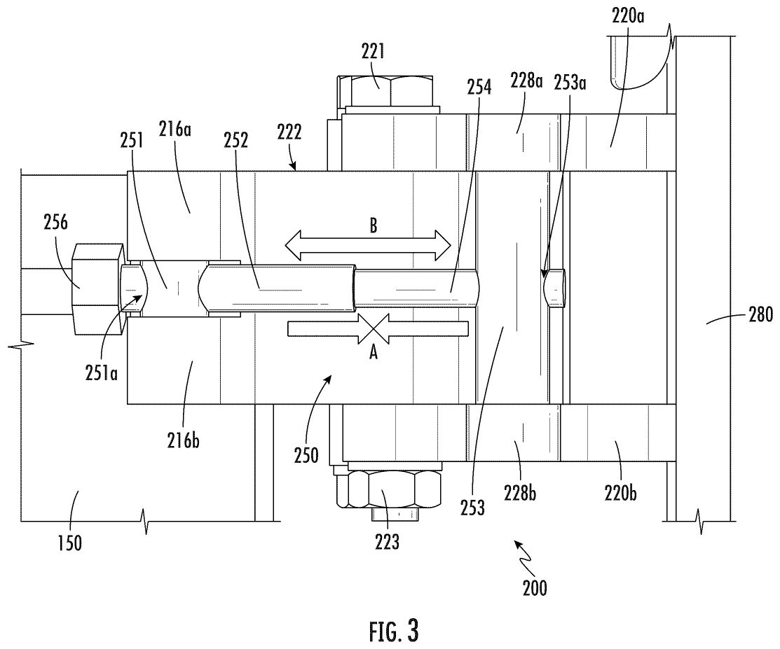

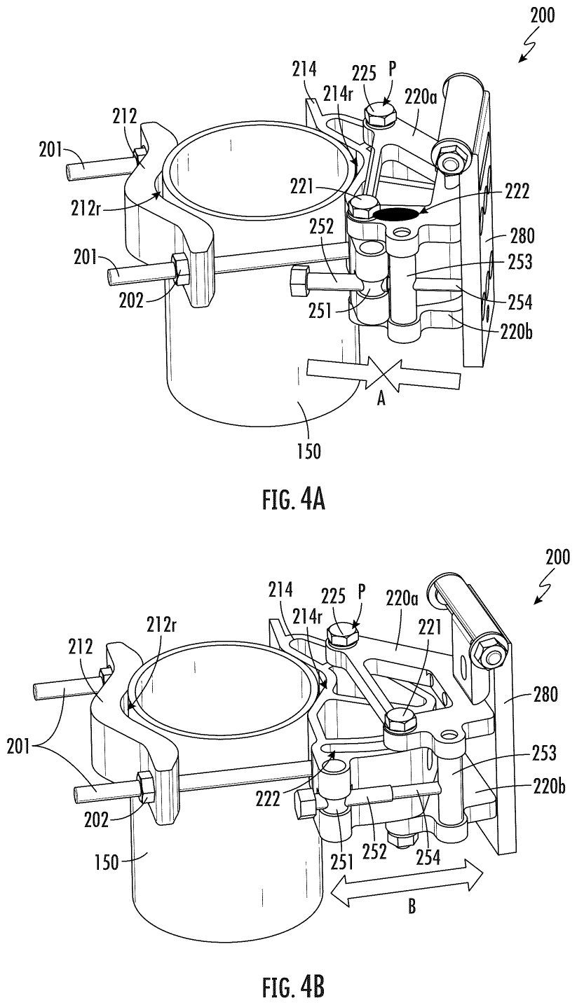

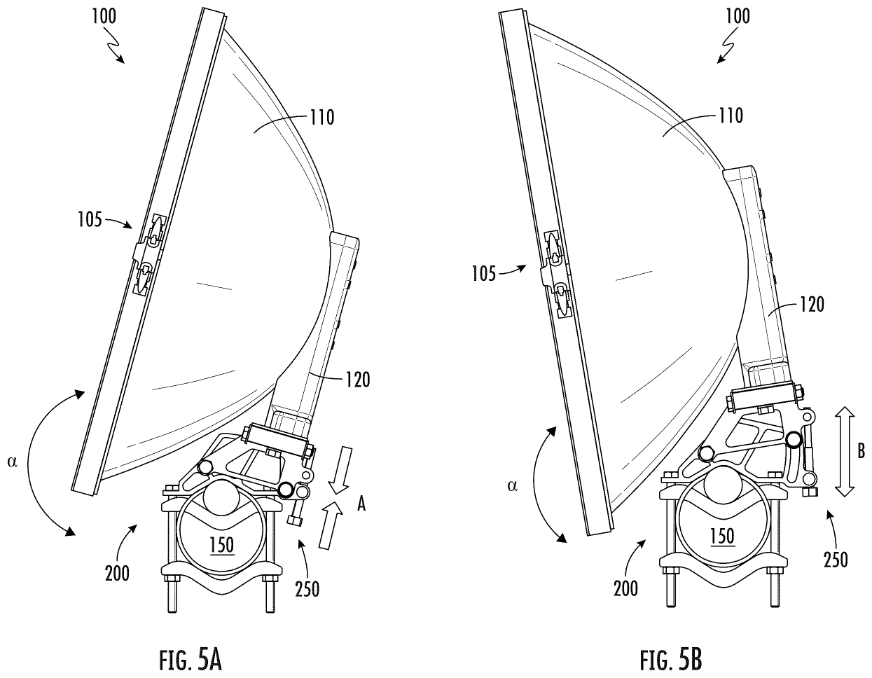

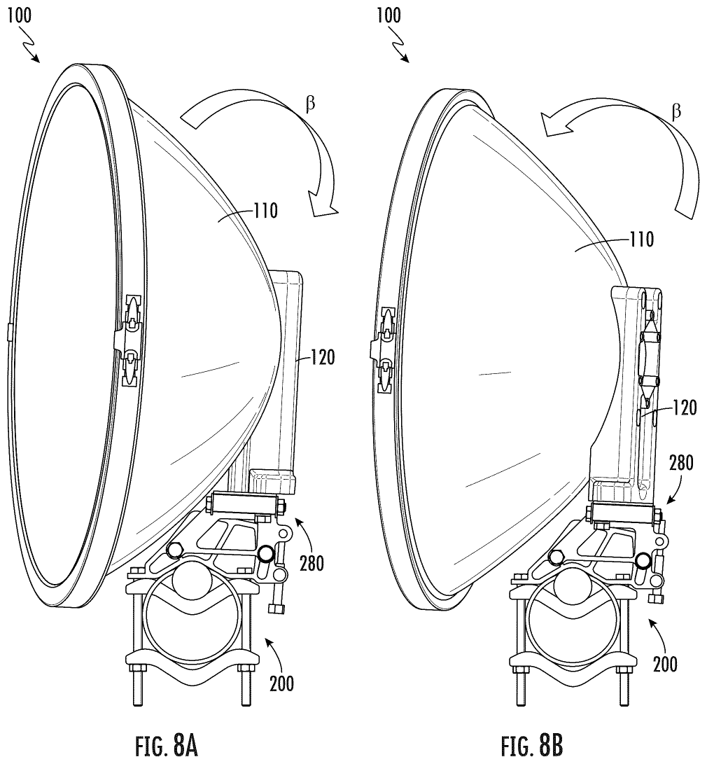

Referring to FIG. 2, FIG. 3, and FIGS. 4A-4B, the antenna mount 200 of the present invention is illustrated in greater detail. According to embodiments of the present invention, the antenna mount 200 is configured to adjust the azimuth alignment of the antenna 105 (and main reflector 110) coupled thereto (see, e.g., FIGS. 5A-5B). In other embodiments, the antenna mount 200 may also be configured to adjust the elevation alignment of the antenna 105 (see, e.g., FIGS. 8A-8B). The antenna mount of the present invention may be compatible for use with currently available products (e.g., antennas 105, reflector mounts 120, etc.). In some embodiments, the antenna mount 200 of the present invention allows for two-axis movement as well as finer resolution control than currently available mounts (i.e., with respect to azimuth and elevation adjustments).

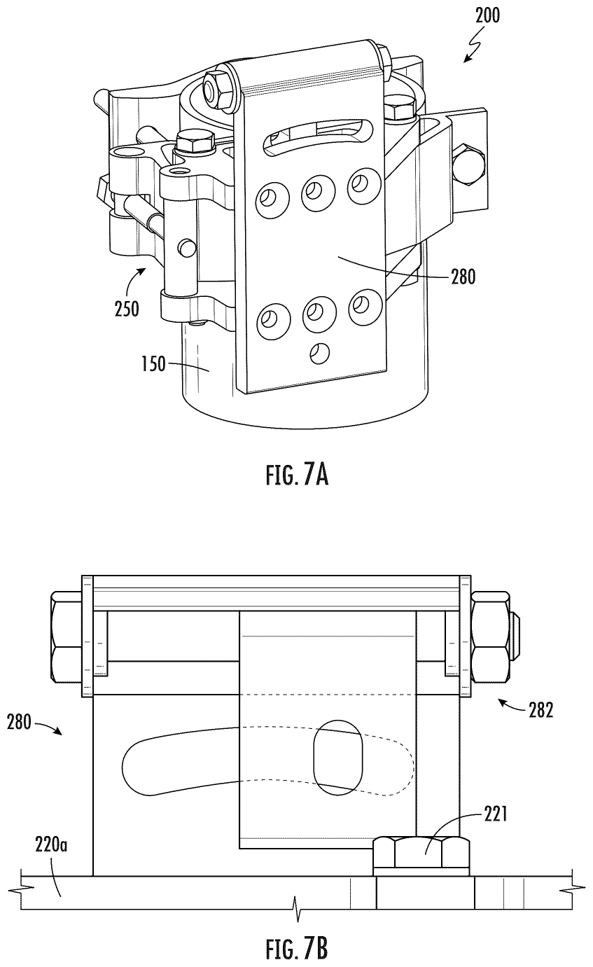

As shown in FIGS. 2-4B, in some embodiments, the antenna mount 200 includes a clamp section 210, one or more adjustable plates 220, and an azimuth adjustment mechanism 250. In some embodiments, the antenna mount 200 includes a pair of adjustable plates 220a, 220b. In some embodiments, the antenna mount 200 may further include an elevation adjuster 280 which may be coupled to the one or more adjustable plates 220 (see also, e.g., FIGS. 7A-7B and FIGS. 8A-8B). The clamp section 210 includes one or more clamping members. For example, as shown in FIG. 2, in some embodiments, the clamp section 210 includes a pair of clamping members 212, 214. The clamping members 212, 214 are configured to engage a mounting structure 150 (e.g., a mounting pole or pipe) therebetween in order to secure the antenna mount 200 to the mounting structure 150 (see, e.g., FIGS. 4A-4B). In some embodiments, the clamping members 212, 214 are held together by two threaded bolts or rods 201 extending through apertures 212a, 214 in each of the respective clamping members 212, 214, which are secured with nuts 202. Tightening of the bolts or rods 201 enables the clamping members 212, 214 to engage the mounting structure 150, with the mounting structure 150 being held between recesses 212r, 214r in the respective clamping members 212, 214 (see, e.g., FIGS. 4A-4B). The clamp section 210 may provide better stability for the antenna mount 200, for example, in windy conditions.

As shown in FIG. 2 and FIG. 3, in some embodiments, the adjustable plates 220a, 220b and azimuth adjustment mechanism 250 are coupled to one of the clamping members 214. In some embodiments the one or more adjustable plates 220a, 220b are pivotably coupled to the one or more of the clamping members 212, 214. For example, in some embodiments, the adjustable plates 220a, 220b are coupled to clamping member 214. As shown in FIG. 2, in some embodiments, two fasteners 221, 225 (e.g., bolts) secure the adjustable plates 220a, 220b to a top surface and an opposing bottom surface of the clamping member 214, respectively. In some embodiments, the first fastener 221 is received through an elongated slot 222 in the clamping member 214 and is configured to traverse within the elongated slot 222. The second fastener 225 is received through an opposing aperture 213 in the clamping member 214. The second fastener 225 creates a pivot point P which allows the adjustable plates 220 to move relative to the top and bottom surfaces of the clamping member 214. In some embodiments, the first and second fasteners 221, 225 may be secured with nuts 223 (see, e.g., FIG. 3). In some embodiments, the azimuth adjustment mechanism 250 is positioned proximate to the elongated slot 222 in the clamping member 214. As discussed in further detail below, through rotation of the azimuth adjustment mechanism 250, the adjustable plates 220a, 220b are configured to linearly move relative to the top and bottom surfaces of the clamping member 214 (about pivot point P). In other words, the adjustable plates 220a, 220b pivot about the second fastener 225, as the first fastener 221 slides within the elongated slot 222.

In most instances, current azimuth adjustment for a point-to-point antenna requires two nuts to be positioned and locked off, and if done in the incorrect order, the antenna 105 (and main reflector 110) could be misaligned by 0.X degrees, for example, misaligned in a range of between about 0.1 degrees to about 1.0 degrees. The azimuth adjustment mechanism 250 of the present invention allows for finer resolution adjustments in azimuth alignment compared to current methods. This is done by providing a pivot point P (i.e., fastener 225) that has tighter tolerances and a threaded pivot (i.e., first and second threaded sections 252, 254 of the azimuth adjustment mechanism 250). In addition, the azimuth adjustment mechanism 250 of the present invention does not require a lock off. In some embodiments, the azimuth adjustment mechanism 250 has a larger offset from the pivot point P than mounts that are currently available in the market.

Further details of the azimuth adjustment mechanism 250 of the antenna mount 200 of the present invention are illustrated in FIG. 3. As shown in FIG. 3, in some embodiments, the azimuth adjustment mechanism 250 comprises a first threaded section 252 coupled to a second threaded section 254. In some embodiments, the first threaded section 252 comprises a right-hand thread and the second threaded section 254 comprises a left-hand thread, or vice versa. In some embodiments, the first threaded section 252 is an M10 right-hand threaded bolt and the second threaded section 254 is machined to M8 left-hand threaded bolt. In some embodiments, the first threaded section 252 may comprise a bolt head 256 (e.g., a hex bolt head). In other embodiments, the second threaded section 254 may comprise the bolt head 256. In some embodiments, the bolt head 256 may be attached to one or both ends of the threaded sections 252, 254 by a joining process. In some embodiments, the bolt head 256 resides between the first and second threaded sections 252, 254. The different thread sizes for the threaded sections 252, 254 allows assembly of the azimuth adjustment mechanism 250 to include the bolt head 256 at either end of the mechanism 250 without having to use any special manufacturing processes; however, in some embodiments threaded sections 252, 254 of similar diameter may be employed.

As further shown in FIG. 3, in some embodiments, the azimuth adjustment mechanism 250 further includes a first boss member 251 and a second boss member 253. In some embodiments, the first boss member 251 is coupled to the clamping member 214. In some embodiments, the first boss member 251 is secured between two flanged edges 216a, 216b of the clamping member 214 (see also, e.g., FIG. 2). In some embodiments, the second boss member 253 is coupled to the adjustable plates 220a, 220b. In some embodiments, the second boss member 253 is secured between respective flanged edges 228a, 228b of the adjustable plates 220a, 220b, thereby coupling the adjustable plates 220a, 220b together such that both adjustable plates 220a, 220b move together relative to the clamping member 214.

As shown in FIG. 3, in some embodiments, the first threaded section 252 extends through an aperture 251a in the first boss member 251 and the second threaded section 254 extends through an aperture 253a in the second boss member 253. The azimuth adjustment mechanism 250 is configured such that, as the first threaded section 252 (or second threaded section 254) is rotated (i.e., clockwise or counterclockwise), the first and second boss members 251, 253 move toward (i.e., pulled) each other or away from (i.e., pushed) each other (see also, e.g., FIGS. 4A-4B).

Referring to FIGS. 4A-4B and FIGS. 5A-5B, adjustment of the azimuth alignment for the antenna assembly 100 utilizing the antenna mount 200 described herein is illustrated. As shown in FIG. 4A and FIG. 5A, in some embodiments, as the azimuth adjustment mechanism 250 is rotated clockwise (indicated by arrows labeled “A”), the first and second boss members 251 are pulled toward each other. As the first and second boss members 251, 253 are pulled toward each other, the adjustable plates 220a, 220b coupled to the second boss member 253 pivot relative to the clamping member 214 about the second fastener 225 (pivot point P) as the first fastener 221 traverses in a first direction within the elongated slot 222 of the clamping member 214, thereby adjusting an azimuth angle α for the main reflector 110 in a first direction (see, e.g., FIG. 5A). As shown in FIG. 4B and FIG. 5B, in some embodiments, as the azimuth adjustment mechanism 250 is rotated counterclockwise (indicated by arrows labeled “B”), the first and second boss members 251, 253 are pushed away from each other.

Similarly, as the first and second boss members 251, 253 are pushed away from each other, the adjustable plates 220a, 220b coupled to the second boss member 253 pivot relative to the clamping member 214 about the second fastener 225 (pivot point P) as the first fastener 221 traverses in a second opposing direction within the elongated slot 222 of the clamping member 214, thereby adjusting an azimuth angle α for the main reflector 110 in a second opposing direction (see, e.g., FIG. 5A). In some embodiments, the antenna mount 200 is configured to adjust the azimuth angle α for the main reflector 110 in a range of between about +12.5 degrees and about −12.5 degrees.

It is noted that in other embodiments, that the antenna mount 200 may be configured such that rotation of the azimuth adjustment mechanism 250 in a clockwise direction pushes the first and second boss members 251, 253 away from each other and rotation in a counterclockwise direction pulls the first and second boss members 251, 253 toward each other.

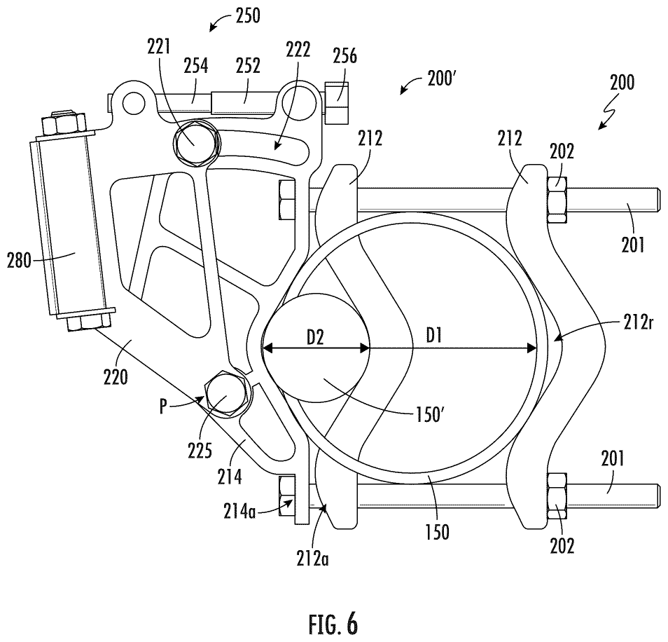

As illustrated in FIG. 6, in some embodiments, the antenna mount 200 of the present invention may be capable of being secured to mounting structures 150, 150′ having different diameters D1, D2. For example, as shown in FIG. 6, in some embodiments, the antenna mount 200 is capable of being secured to a mounting structure 150 having a diameter D1 or a mounting structure 150′ having a smaller diameter D2. In some embodiments, the antenna mount 200 is configured to be secured to mounting structures 150, 150′ having diameters D1, D2 in a range of between about 48 millimeters and about 120 millimeters. In some embodiments, the recesses 212r, 214r of the clamping members 212, 214 of the antenna mount 200 may comprise a plurality of protrusions (e.g., teeth) (not shown) that are configured to help increase the grip of the clamping members 212, 214 on the mounting structure 150, 150′.

As noted above, in some embodiments, the antenna mount 200 of the present invention may further include an elevation adjuster 280 coupled to the adjustable plates 220a, 220b. An exemplary elevation adjuster 280 is further illustrated in FIGS. 7A-7B and FIGS. 8A-8B. In some embodiments, the reflector mount 120 is secured to the elevation adjuster 280. As shown in FIGS. 7A-7B and FIGS. 8A-8B, the elevation adjuster 280 is configured to pivot the reflector mount 120 (and main reflector 110) coupled thereto to a desired angle of elevation β for the main reflector 110 relative to the antenna mount 200.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. An antenna mount, the antenna mount comprising:
a clamp section comprising one or more clamping members, the one or more clamping members configured to engage a mounting structure;
at least one adjustable plate pivotably coupled to at least one clamping member of the one or more clamping members; and
an azimuth adjustment mechanism coupled to the one or more the clamping members and the at least one adjustable plate,
wherein, through rotation of the azimuth adjustment mechanism, the at least one adjustable plate is configured to linearly move relative to the one or more clamping members to adjust an azimuth alignment of an antenna coupled thereto.

2. The antenna mount according to claim 1, wherein the antenna mount comprises a pair of adjustable plates and the clamp section comprises a pair of clamping members, and wherein the pair of clamping members are held together by two threaded bolts extending through apertures in each of the respective clamping members and secured with nuts, and wherein tightening of the bolts enables the clamping members to engage a mounting structure with the mounting structure held between recesses in the respective clamping members.

3. The antenna mount according to claim 1, wherein the pair of adjustable plates are secured to a top surface and an opposing bottom surface of the clamping member via a first fastener extending through an elongated slot and a second fastener extending through an aperture, wherein the first fastener is configured to traverse within the elongated slot and the second fastener creates a pivot point, thereby allowing the adjustable plates to move relative to the top and bottom surfaces of the clamping member.

4. The antenna mount according to claim 1, wherein the azimuth adjustment mechanism comprises a first threaded section coupled to a second threaded section, the first threaded section having a right-hand thread and the second threaded section having a left hand thread.

5. The antenna mount according to claim 4, wherein the azimuth adjustment mechanism further comprises a first boss member coupled to the clamping member and a second boss member coupled to the pair of adjustable plates, wherein the first threaded section extends through an aperture in the first boss member and the second threaded section extends through an aperture in the second boss member, wherein the azimuth adjustment mechanism is configured such that as the first or second threaded section is rotated, the first and second boss members move toward each other or away from each other.

6. The antenna mount according to claim 5, wherein the first boss member is secured between two flanged edges of the clamping member and the second boss member is secured between respective flanged edges of the adjustable plates.

7. The antenna mount according to claim 5, wherein:
when the azimuth adjustment mechanism is rotated clockwise, the first and second boss members are pulled toward each other which causes the adjustable plates coupled to the second boss member to pivot relative to the clamping member about the second fastener as the first fastener traverses in a first direction within the elongated slot of the clamping member, and
when the azimuth adjustment mechanism is rotated counterclockwise, the first and second boss members are pushed as way from each other which causes the adjustable plates coupled to the second boss member to pivot relative to the clamping member about the second fastener as the first fastener traverses in a second opposite direction within the elongated slot of the clamping member,
thereby adjusting the azimuth alignment for the antenna.

8. The antenna mount according to claim 1, wherein the antenna mount is configured to adjust the azimuth angle of the antenna in a range of between about +12.5 degrees and about −12.5 degrees.

9. The antenna mount according to claim 1, further comprising an elevation adjuster configured to adjust the elevation alignment of an antenna secured to the antenna mount.

10. An antenna mount, the antenna mount comprising:
a clamp section comprising a pair of clamping members, the clamping members configured to engage a mounting structure;
a pair of adjustable plates pivotably coupled to one of the clamping members; and
an azimuth adjustment mechanism coupled to one of the clamping members and the pair of adjustable plates, the azimuth adjustment mechanism comprising:
a first threaded section coupled to a second threaded section, the first threaded section having a right-hand thread and the second threaded section having a left hand thread;
a first boss member coupled to the clamping member; and
a second boss member coupled to the pair of adjustable plates,
wherein the first threaded section extends through an aperture in the first boss member and the second threaded section extends through an aperture in the second boss member,
wherein the azimuth adjustment mechanism is configured such that as the first or second threaded section is rotated, the first and second boss members move toward each other or away from each other which cause the pair of adjustable plates to linearly move relative to the clamping member to adjust an azimuth alignment of an antenna coupled thereto.

11. The antenna mount according to claim 10, wherein the pair of clamping members are held together by two threaded bolts extending through apertures in each of the respective clamping members and secured with nuts, and wherein tightening of the bolts enables the clamping members to engage a mounting structure with the mounting structure held between recesses in the respective clamping members.

12. The antenna mount according to claim 10, wherein the pair of adjustable plates are secured to a top surface and an opposing bottom surface of the clamping member via a first fastener extending through an elongated slot and a second fastener extending through an aperture, wherein the first fastener is configured to traverse within the elongated slot and the second fastener creates a pivot point, thereby allowing the adjustable plates to move relative to the top and bottom surfaces of the clamping member.

13. The antenna mount according to claim 10, wherein:
when the azimuth adjustment mechanism is rotated clockwise, the first and second boss members are pulled toward each other which causes the adjustable plates coupled to the second boss member to pivot relative to the clamping member about the second fastener as the first fastener traverses in a first direction within the elongated slot of the clamping member, and
when the azimuth adjustment mechanism is rotated counterclockwise, the first and second boss members are pushed as way from each other which causes the adjustable plates coupled to the second boss member to pivot relative to the clamping member about the second fastener as the first fastener traverses in a second opposite direction within the elongated slot of the clamping member,
thereby adjusting the azimuth alignment for the antenna.

14. The antenna mount according to claim 10, wherein the antenna mount is configured to adjust the azimuth angle of the antenna in a range of between about +12.5 degrees and about −12.5 degrees.

15. An antenna mount assembly, the antenna mount assembly comprising:
a mounting structure;
an antenna having a main reflector; and
an antenna mount configured to secure the antenna to the mounting structure, the antenna mount comprising:
a clamp section comprising a pair of clamping members, the clamping members configured to engage a mounting structure;
a pair of adjustable plates pivotably coupled to one of the clamping members; and
an azimuth adjustment mechanism coupled to one of the clamping members and the pair of adjustable plates,
wherein, through rotation of the azimuth adjustment mechanism, the pair of adjustable plates are configured to linearly move relative to the clamping member to adjust an azimuth alignment of the antenna.

16. The antenna mount according to claim 15, wherein the pair of adjustable plates are secured to a top surface and an opposing bottom surface of the clamping member via a first fastener extending through an elongated slot and a second fastener extending through an aperture, wherein the first fastener is configured to traverse within the elongated slot and the second fastener creates a pivot point, thereby allowing the adjustable plates to move relative to the top and bottom surfaces of the clamping member.

17. The antenna mount according to claim 15, wherein the azimuth adjustment mechanism comprises a first threaded section coupled to a second threaded section, the first threaded section having a right-hand thread and the second threaded section having a left hand thread, wherein the first threaded section is an M10 right-hand threaded bolt and the second threaded section is machined to M8 left-hand threaded bolt

18. The antenna mount according to claim 17, wherein the azimuth adjustment mechanism further comprises a first boss member coupled to the clamping member and a second boss member coupled to the pair of adjustable plates, wherein the first threaded section extends through an aperture in the first boss member and the second threaded section extends through an aperture in the second boss member, wherein the azimuth adjustment mechanism is configured such that as the first or second threaded section is rotated, the first and second boss members move toward each other or away from each other.

19. The antenna mount according to claim 18, wherein:
when the azimuth adjustment mechanism is rotated clockwise, the first and second boss members are pulled toward each other which causes the adjustable plates coupled to the second boss member to pivot relative to the clamping member about the second fastener as the first fastener traverses in a first direction within the elongated slot of the clamping member, and
when the azimuth adjustment mechanism is rotated counterclockwise, the first and second boss members are pushed away from each other which causes the adjustable plates coupled to the second boss member to pivot relative to the clamping member about the second fastener as the first fastener traverses in a second opposite direction within the elongated slot of the clamping member,
thereby adjusting the azimuth alignment for the antenna.

20. The antenna mount according to claim 18, wherein:
when the azimuth adjustment mechanism is rotated clockwise, the first and second boss members are pushed away from each other which causes the adjustable plates coupled to the second boss member to pivot relative to the clamping member about the second fastener as the first fastener traverses in a second opposite direction within the elongated slot of the clamping member,
when the azimuth adjustment mechanism is rotated counterclockwise, the first and second boss members are pulled toward each other which causes the adjustable plates coupled to the second boss member to pivot relative to the clamping member about the second fastener as the first fastener traverses in a first direction within the elongated slot of the clamping member, and
thereby adjusting the azimuth alignment for the antenna.
